(19) United States
(12) Patent Application Publication
(10) Pub. No.: US 2025/0372110 A1
(43) Pub. Date: Dec. 4, 2025

(54) CUSTOMIZED AUDIO RENDERING

(71) Applicant: Nokia Technologies Oy, Espoo (FI)

(72) Inventors: Jussi Artturi LEPPÄNEN, Tampere (FI); Arto Juhani LEHTINIEMI, Tampere (FI); Tapani PIHLAJAKUJA, Espoo (FI)

(21) Appl. No.: 19/205,574

(22) Filed: May 12, 2025

(30) Foreign Application Priority Data
May 29, 2024 (GB) 2407567.3

(51) Int. Cl. G10L 21/02; H04R 25/00

(52) U.S. Cl. CPC G10L 21/02; H04R 25/70

(57) ABSTRACT

An apparatus comprising means for:
providing an audio intelligibility mode or audio accessibility mode in which a ratio of indirect audio to direct audio for an audio source is reduced compared to another mode on a per audio source basis
wherein
a priority audio source is rendered:
with a first reduction in the ratio of indirect audio to direct audio, if it is a speech audio source; and
with a second reduction, or no reduction, in the ratio of indirect audio to direct audio, if it is not a speech audio source, wherein the second reduction is less than the first reduction.

### TECHNOLOGICAL FIELD

Examples of the disclosure relate to apparatuses, methods, computer programs for customizing audio rendering.

### BACKGROUND

It can be desirable to provide users of electronic devices with options to customize their listening experience via customized audio rendering.

One such option is a “speech intelligibility” mode that improves the intelligibility of rendered speech. This can, for example, reduce non-direct audio from the speech audio source such as ambient audio.

One such option is an “audio accessibility” setting that improves the accessibility of audio to a person with a hearing impairment. This can, for example reduce the ratio of indirect audio to direct audio from all audio sources.

### BRIEF SUMMARY

According to various, but not necessarily all, embodiments there is provided examples as claimed in the appended claims.

According to various, but not necessarily all, embodiments there is provided an apparatus comprising means for:
providing an audio intelligibility mode or audio accessibility mode in which a ratio of indirect audio to direct audio for an audio source is reduced compared to another mode on a per audio source basis
wherein
a priority audio source is rendered:
with a first reduction in the ratio of indirect audio to direct audio, if it is a speech audio source; and
with a second reduction, or no reduction, in the ratio of indirect audio to direct audio, if it is not a speech audio source, wherein the second reduction is less than the first reduction.

In some but not necessarily all examples, the apparatus is configured to identify an audio source as a speech audio source based on per audio source metadata that indicates how the audio source is to be rendered in the audio intelligibility mode or audio accessibility mode.

In some but not necessarily all examples, the per audio source metadata indicates that the audio object is a speech audio object.

In some but not necessarily all examples, the per audio source metadata is content-creator-controlled.

In some but not necessarily all examples, the per audio source metadata is content-creator-controlled.

In some but not necessarily all examples, when, during the audio intelligibility mode or audio accessibility mode, a priority speech audio source is rendered with a first reduction in the ratio of indirect audio to direct audio, non-priority audio sources are rendered with a reduction in the ratio of indirect audio to direct audio.

In some but not necessarily all examples, when, during the audio intelligibility mode or audio accessibility mode, a priority speech audio source is rendered with a first reduction in the ratio of indirect audio to direct audio, then all other non-speech sources are rendered with a reduction in the ratio of indirect audio to direct audio.

In some but not necessarily all examples, the another mode is a mode operational if the audio intelligibility mode or audio accessibility mode has not been user activated.

In some but not necessarily all examples, a non-speech object can be a priority audio object only when there is no priority speech object

In some but not necessarily all examples, a per audio source priority is dependent upon a listening position in a sound scene relative to the audio source.

In some but not necessarily all examples, the listening position is dependent upon a listening location and/or a listening environment and/or a listening orientation.

In some but not necessarily all examples, the per audio source priority is dependent upon a distance from the listening position to the audio source.

In some but not necessarily all examples, the per audio source priority is dependent upon a direct distance from the listening position to the audio source.

In some but not necessarily all examples, the listening position is controlled to track a head position, location and orientation, of a user of the apparatus.

In some but not necessarily all examples, a per audio source priority is dependent upon hearability of the audio source, which is dependent upon at least relative amplitude of the audio source.

In some but not necessarily all examples, a per audio source priority is dependent upon per audio source metadata.

In some but not necessarily all examples, the per audio source metadata is comprised in a scene description bitstream.

In some but not necessarily all examples, the accessibility mode is an MPEG accessibility mode with the first reduction in the ratio of indirect audio to direct audio of the audio source, if it is a priority speech audio source, being controlled using reverbAttenuationDb and erAttenuationDb.

In some but not necessarily all examples, the second reduction in the ratio of indirect audio to direct audio for the audio source, if it is not a priority speech audio source, being controlled using reverbAttenuationDb and erAttenuationDb.

According to various, but not necessarily all, embodiments there is provided a method for providing an audio intelligibility mode or audio accessibility mode in which a ratio of indirect audio to direct audio for an audio source is controlled, comprising:
if an audio source is a priority speech audio source;
causing rendering of the audio source with a first ratio of indirect audio to direct audio,
and
if the audio source is not a priority speech audio source,
rendering the audio source with a second ratio of indirect audio to direct audio, wherein the first ratio of indirect audio to direct audio is lower than the second ratio of indirect audio to direct audio.

According to various, but not necessarily all, embodiments there is provided a computer program that when executed by one or more processors causes an apparatus to
determine if an audio source is a priority speech audio source;
if an audio source is a priority speech audio source, cause rendering of the audio source with a first ratio of indirect audio to direct audio,
and
if the audio source is not a priority speech audio source, cause rendering of the audio source with a second ratio of indirect audio to direct audio, wherein the first ratio of indirect audio to direct audio is lower than the second ratio of indirect audio to direct audio.

According to various, but not necessarily all, embodiments there is provided an apparatus comprising means for
encoding an audio bitstream including per audio object command information to control a decoder operation during an audio intelligibility or audio accessibility mode wherein the per object command information identifies an audio object as a speech object for differential rendering.

In some but not necessarily all examples, the apparatus comprises means for receiving an input according to an encoder Input Format (EIF) specification, comprising an authoring parameter for defining the per object command information identifying the audio object as a speech object for differential rendering.

In some but not necessarily all examples, the apparatus comprises means for receiving an input according to an encoder Input Format (EIF) specification, comprising a flag to indicate whether the audio object contains speech for defining the per object command information identifying the audio object as a speech object for differential rendering.

In some but not necessarily all examples, the per audio object command information is configured to control a decoder operation during an audio intelligibility or audio accessibility mode to render a priority audio object with a reduction in a ratio of indirect audio to direct audio compared to a another mode, if it is a speech object and with a second reduction, or no reduction, in a ratio of indirect audio to direct audio compared to the another mode, if it is not a speech object, wherein the second reduction is less than the first reduction.

In some but not necessarily all examples, the apparatus is configured to insert into the bitstream, per audio object prioritization information to control prioritization of the audio object.

In some but not necessarily all examples, the prioritization information defines a hearability threshold for the speech object.

According to various, but not necessarily all, embodiments there is provided a method comprising:
encoding an audio bitstream including per audio object command information to control a decoder operation during an audio intelligibility or audio accessibility mode wherein the per object command information identifies an audio object as a speech object for differential rendering.

According to various, but not necessarily all, embodiments there is provided a computer program that when executed by one or more processors causes an apparatus to encode an audio bitstream including per audio object command information to control a decoder operation during an audio intelligibility or audio accessibility mode wherein the per object command information identifies an audio object as a speech object for differential rendering.

According to various, but not necessarily all, embodiments there is provided a system comprising an apparatus for encoding audio as an encoded bitstream and at least an apparatus for decoding the encoded bitstream.

While the above examples of the disclosure and optional features are described separately, it is to be understood that their provision in all possible combinations and permutations is contained within the disclosure. It is to be understood that various examples of the disclosure can comprise any or all the features described in respect of other examples of the disclosure, and vice versa. Also, it is to be appreciated that any one or more or all the features, in any combination, may be implemented by/comprised in/performable by an apparatus, a method, and/or computer program instructions as desired, and as appropriate. The description of a function should additionally be considered to also disclose any means suitable for performing that function

### BRIEF DESCRIPTION

Some examples will now be described with reference to the accompanying drawings in which:

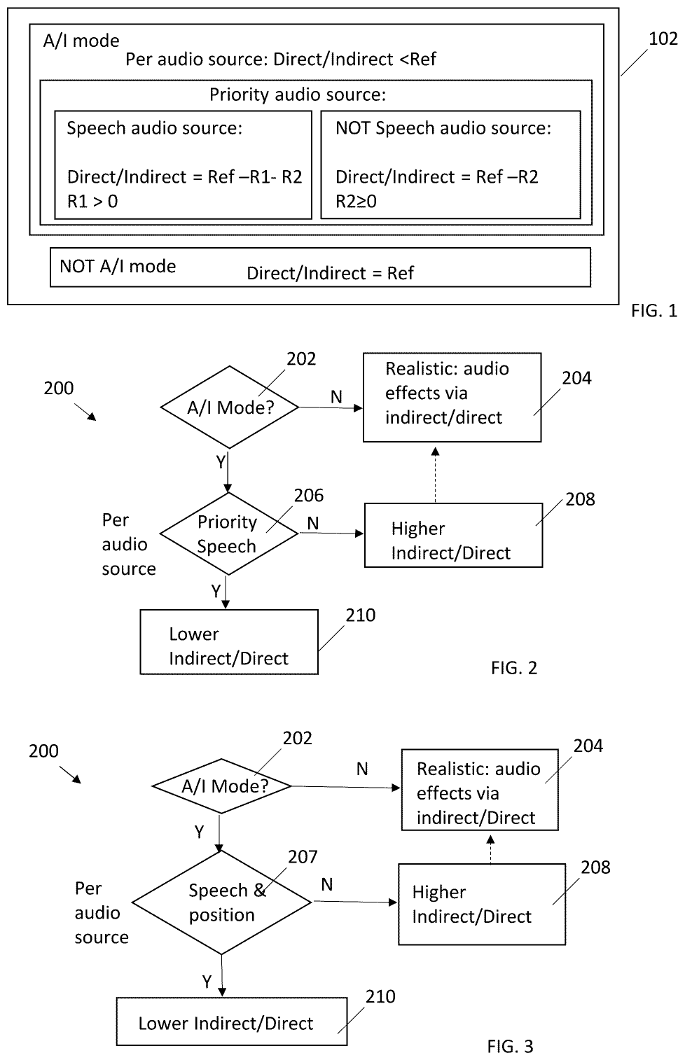

FIG. 1 shows an example of an apparatus 102 that, during an audio intelligibility mode or audio accessibility mode, controls a ratio of indirect audio to direct audio for an audio source in dependence upon whether or not the audio source is a priority speech audio source;

FIG. 2 shows an example of a method that, during an audio intelligibility mode or audio accessibility mode, controls a ratio of indirect audio to direct audio for an audio source in dependence upon whether or not the audio source is a priority;

FIG. 3 shows an example of a method that, during an audio intelligibility mode or audio accessibility mode, controls a ratio of indirect audio to direct audio for an audio source in dependence upon whether or not the audio source is a priority (based on position);

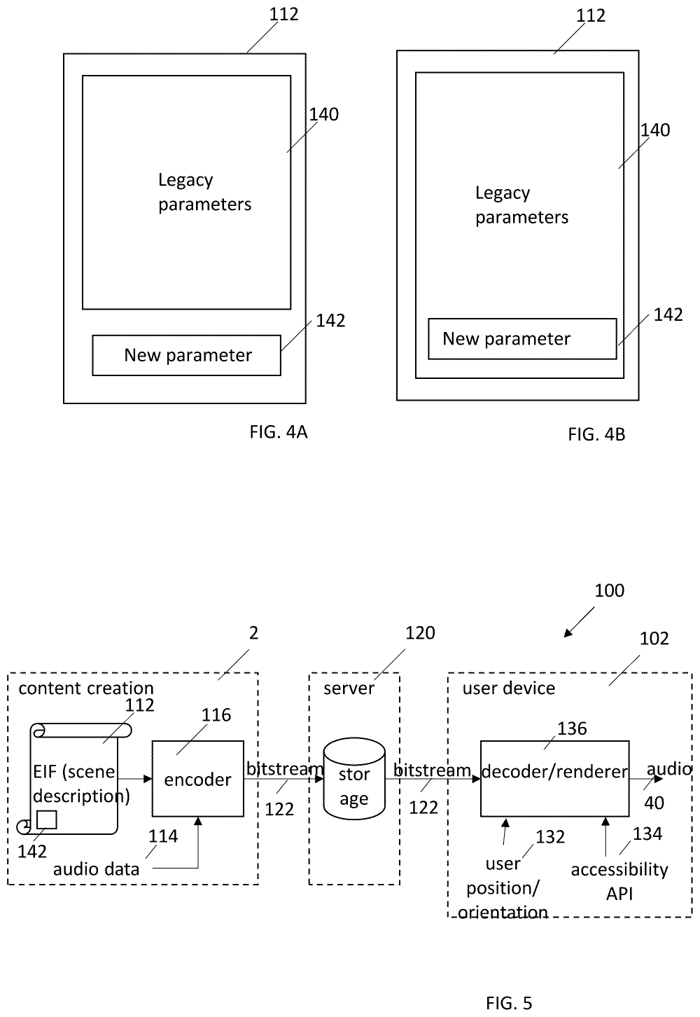

FIGS. 4A and 4B illustrate different examples of formats of metadata for identify whether or not an audio source is a speech audio source;

FIG. 5 illustrates an example of a system for encoding audio using an encoder apparatus 2 and decoding audio using a decoding apparatus 102;

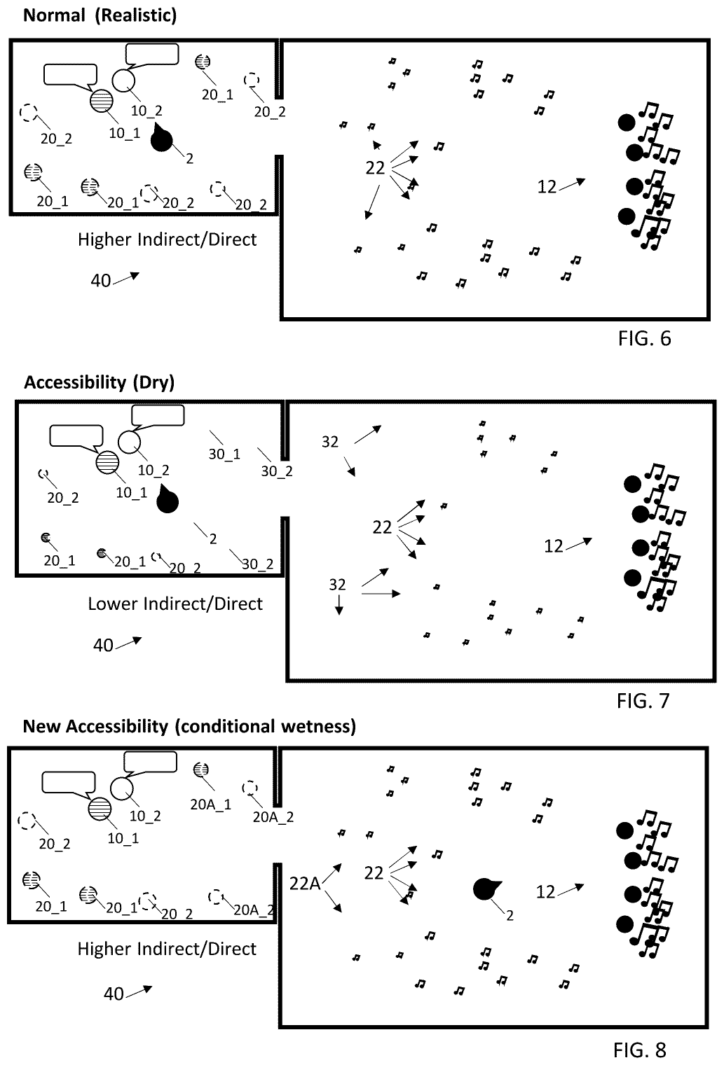

FIG. 6 illustrates an example of rendering audio sources with a controlled higher ratio of indirect to direct audio when neither the audio intelligibility mode nor audio accessibility mode is active;

FIG. 7 illustrates an example of rendering audio sources with a controlled lower ratio of indirect to direct audio during an audio intelligibility mode or audio accessibility mode is active and there is a priority (proximal) speech audio source;

FIG. 8 illustrates an example of rendering audio sources with controlled ratios of indirect to direct audio (higher than FIG. 7) during an audio intelligibility mode or audio accessibility mode is active and there is not a priority (proximal) speech audio source;

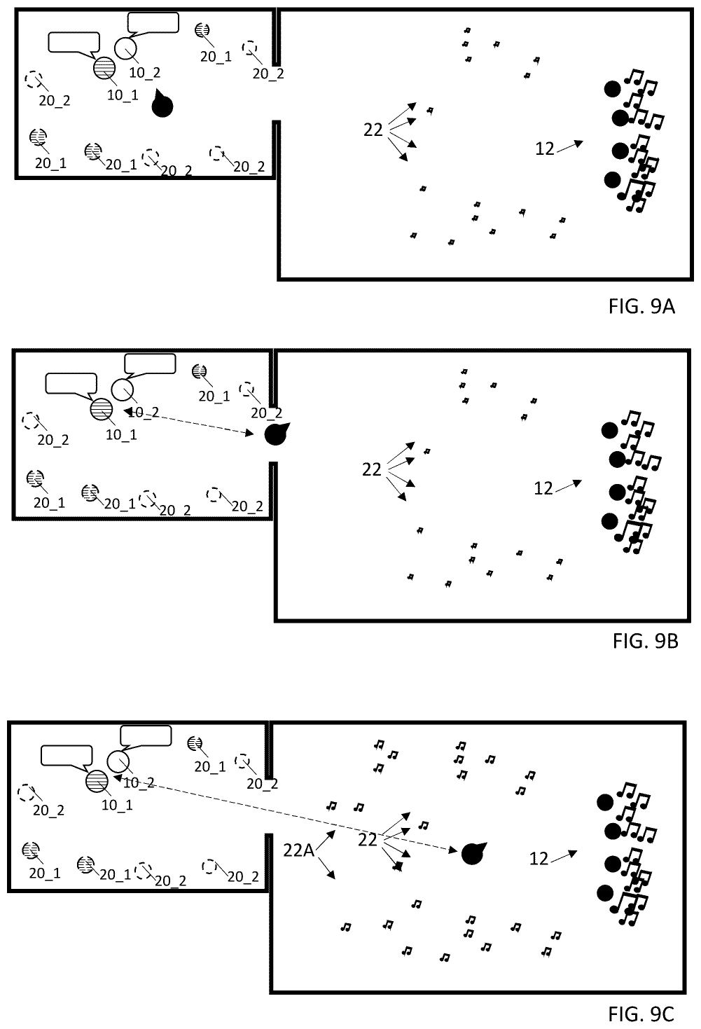

FIGS. 9A and 9B illustrates examples of rendering audio sources with a controlled lower ratio of indirect to direct audio during an audio intelligibility mode or audio accessibility mode is active and there is a priority (proximal) speech audio source, and FIG. 9C FIG. 8 illustrates an example of rendering audio sources with controlled ratios of indirect to direct audio (higher than FIG. 9A and 9B) during an audio intelligibility mode or audio accessibility mode is active and there is not a priority (proximal) speech audio source;

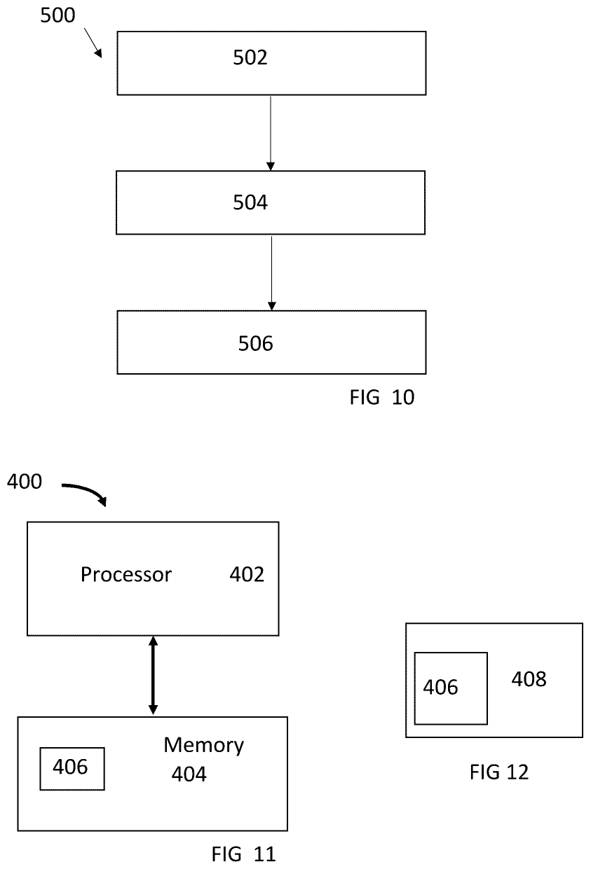

FIG. 10 illustrates an example of a method;

FIG. 11 illustrates an example of controller'

FIG. 12 illustrates an example of a computer program.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

In the following an apparatus 102 comprises means for:
providing an audio intelligibility mode or audio accessibility mode in which a ratio of indirect audio to direct audio for an audio source is reduced compared to another mode on a per audio source basis, wherein a priority audio source is rendered:
with a first reduction in the ratio of indirect audio to direct audio, if it is a speech audio source; and
with a second reduction, or no reduction, in the ratio of indirect audio to direct audio, if it is not a speech audio source, wherein the second reduction is less than the first reduction.

The apparatus 102 is an apparatus that decodes encoded audio for rendering. In at least some examples, the apparatus 102 is also a rendering device that produces one or more bitstreams for rendering by respective audio transducers. The audio transducers can, for example, be room transducers (e.g. loudspeakers) or ear transducers (e.g. in-ear, on-ear, or over-ear devices for one or both ears).

An audio intelligibility mode is a mode that is used to make audio, often speech, more intelligible. An audio accessibility mode is a mode that is used to make audio, often speech, more accessible to a listener with a hearing impairment.

The apparatus 102 provides a new type of audio intelligibility mode or audio accessibility mode that has ‘intelligence’.

During an audio intelligibility/accessibility mode, audio is rendered with increased intelligibility (or increased accessibility) when appropriate but not always (e.g. for a priority speech object, but not for other audio objects). The ratio of indirect audio to direct audio is reduced for an audio object when appropriate and not reduced or reduced less otherwise. For example, a ratio of indirect audio to direct audio is reduced for a priority speech object but not necessarily reduced (or if reduced, reduced by a lesser amount) for other audio objects.

Reference is made to the ratio of indirect audio to direct audio per audio source. This is a value, for example energy or amplitude, for indirect audio for the audio source divided by a value for direct audio for the audio source. The ratio may be determined for one or more frequency ranges.

If the ratio of indirect audio to direct audio is determined across multiple frequency ranges, then having the ratio of indirect audio to direct audio larger than a reference value may mean that the ratio of indirect audio to direct audio is larger than a reference value for one frequency range, or for a sub-set of frequency ranges or for all frequency ranges. The comparison reference can be different for different frequency ranges. The comparison reference is the ratio of indirect audio to direct audio for the same audio source in the absence of an intelligibility/accessibility mode.

It should be appreciated that total audio is equal to direct audio added to the indirect audio. The ratio of indirect audio to direct audio can be expressed in terms of the ratio of direct audio to indirect audio. The ratio of indirect audio to direct audio can also be expressed in terms of direct audio and total audio or in terms of indirect audio and total audio. Although the description refers to using the ratio of indirect audio to direct audio, this should be considered to refer to using the actual ratio of indirect audio to direct audio, and also to the use of other formulations such as, for example, the ratio of total audio (direct plus indirect) to direct audio, or the reciprocal of such ratios. The ratio of indirect audio to direct audio should therefore be interpreted in a functional sense (a dependency) rather that a strictly literal sense (an exact expression).

In the art, rendering audio with a lower direct to total audio ratio, a lower direct to indirect audio ratio, or a higher indirect audio to direct audio ratio is described as ‘wet’ rendering. In the art, rendering audio with a higher direct to total audio ratio, a higher direct to indirect audio, or a lower indirect audio to direct audio ratio is described as ‘dry’ rendering. Dry rendering (lower ratio of indirect audio to direct audio) makes speech more intelligible. Wet rendering (higher ratio of indirect audio to direct audio) can make rendering of an audio scene more realistic.

In FIG. 1, the apparatus 102 comprises means for:
providing an audio intelligibility mode or audio accessibility mode in which a ratio of indirect audio to direct audio for an audio source is reduced compared to another mode on a per audio source basis
wherein
a priority audio source is rendered:
with a first reduction in the ratio of indirect audio to direct audio, if it is a speech audio source; and
with a second reduction, or no reduction, in the ratio of indirect audio to direct audio, if it is not a speech audio source, wherein the second reduction is less than the first reduction.

In at least some examples, the another mode is a default mode operational if the audio intelligibility mode or audio accessibility mode has not been user activated. The another mode is therefore not an audio intelligibility mode nor an audio accessibility mode.

In FIG. 1, the ratio of indirect audio to direct audio the other mode (when audio intelligibility mode or audio accessibility mode are not active) is “Ref”. The ratio of indirect audio to direct audio during the audio intelligibility mode (or audio accessibility mode), for an audio object that is not a priority speech object, is reduced by a second reduction R2, which may be greater than or equal to zero. The ratio of indirect audio to direct audio during the audio intelligibility mode (or audio accessibility mode), for an audio object that is a priority speech object, is reduced from Ref by a first reduction R1+R2, which is greater than the second reduction R2.

In some examples, an encoder apparatus (not illustrated in FIG. 1) comprises means for encoding an audio bitstream including per audio source command information to control a decoder operation during an audio intelligibility or audio accessibility mode wherein the per audio source command information identifies an audio source as a speech object for differential rendering.

The decoder apparatus 102 comprises means for decoding the encoded audio bitstream to obtain per audio source command information for controlling decoding operation during an audio intelligibility or audio accessibility mode. The per audio source command information identifies an audio object as a speech object for rendering. This facilitates the decoder apparatus 102 in determining whether an audio object is or is not a priority speech audio object.

FIG. 2 illustrates a method 200 for decoding audio.

At block 202, the method 200 determines whether or not an intelligibility mode I (or an accessibility mode A) is operational.

If the intelligibility mode (or the accessibility mode) is operational, the method moves to block 206. If the intelligibility mode (or the accessibility mode) is not operational, the method moves to block 204.

At block 206, it is determined per audio source, whether the audio source is a priority speech audio source or is not a priority speech audio source.

If it is determined that the audio source is a priority speech audio source, the method moves to block 210. If it is determined that the audio source is not a priority speech audio source, the method moves to block 208.

Thus if it is determined that the audio source is a speech audio source and a priority condition is satisfied, the method moves to block 210. If it is determined that the audio source is a not a speech audio source the method moves to block 208. If it is determined that the audio source is a speech audio source but that a priority condition for the speech audio source is not satisfied, the method moves to block 208.

In some, but not necessarily all examples, the priority condition is a position condition based on a position of the speech audio source. If it is determined that a position of the speech audio source does not satisfy the position condition, the method moves to block 208. If it is determined that a position of the speech audio source does satisfy the position condition, the method moves to block 210.

In some, but not necessarily all examples, the position condition is based on a relative position of the speech audio source and the listener. In some examples, the position condition is dependent upon a distance from a listening position to the audio source. In some examples, the position condition is dependent upon a direct distance from the listening position to the audio source.

At block 204, the method 200 renders realistic audio effects ‘wet’ using realistic values of the ratio of indirect audio to direct audio.

At block 210, the method 200 renders audio effects for intelligibility/accessibility of speech. The speech audio source is rendered ‘dry’ with a first reduction in the ratio of indirect audio to direct audio compared to block 204.

At block 208, the method 200 renders audio effects that are not the same as those used for intelligibility/accessibility of speech at block 210. The constraints applied at block 210 for intelligibility/accessibility of speech are loosened so that the audio source is rendered like or more like it would be at block 204. That is ‘wetter’ and more realistically. The audio source is rendered with a second reduction (‘moist’), or no reduction (‘wet’), in the ratio of indirect audio to direct audio first compared to block 204.

Thus during the audio intelligibility mode (or audio accessibility mode) the audio source is:
i) rendered (block 210), if it is a priority speech audio source, with a first reduction in the ratio of indirect audio to direct audio compared to another mode (block 204) and
ii) otherwise rendered (block 208), if it is not a priority speech audio source, with a second reduction, or no reduction, in the ratio of indirect audio to direct audio compared to another mode (block 204).

FIG. 3 illustrates an example of the method 200 illustrated in FIG. 2. In this example, the prioritization of a speech audio source is dependent upon a position of the speech audio source.

In FIG. 3, it is determined per audio source, whether the audio source is a speech audio source and whether it does or does not satisfy a position condition related to a position of the audio source.

At block 207, it, it is determined per audio source, whether the audio source is an appropriately positioned speech audio source or is not an appropriately positioned speech audio source.

If it is determined that the audio source is an appropriately positioned speech audio source, the method moves to block 210. If it is determined that the audio source is not an appropriately positioned speech audio source, the method moves to block 208.

For example, if it is determined that the audio source is a speech audio source and a position of the audio source satisfies a position condition, the method moves to block 210. If it is determined that the audio source is a not a speech audio source the method moves to block 208. If it is determined that the audio source is a speech audio source but that a position of the speech audio source does not satisfy the position condition the method moves to block 208.

In the examples described previously and later, the apparatus 102 is configured to identify an audio source as a speech audio source. In some examples this is dependent upon an analysis of the audio source to identify it as speech. In other examples, identification of an audio source as a speech audio source is based on per audio source metadata, for example per audio object metadata.

In at least some examples, the metadata indicates how the associated audio source (audio object) is to be rendered in the audio intelligibility mode or audio accessibility mode.

In at least some examples, the per audio source metadata (per audio object metadata) indicates that the respective audio source (audio object) is a speech audio source (speech audio object).

In at least some examples, the per source (object) metadata is content-creator-controlled, that is, the content is controlled by a creator (author).

In at least some examples, the per source (object) metadata is obtained from a scene description bitstream. For example, a moving picture expert group immersive (MPEG-I) defined scene description.

In some examples when, during the audio intelligibility mode or audio accessibility mode, a priority speech audio source is rendered with a first reduction in the ratio of indirect audio to direct audio, then all other audio sources are rendered with a reduction (R2>0) in the ratio of indirect audio to direct audio.

The other audio sources can be priority non-speech audio source and non-priority audio sources (speech and non-speech)

In some examples when, during the audio intelligibility mode or audio accessibility mode, a priority speech audio source is rendered with a first reduction in the ratio of indirect audio to direct audio, then all non-priority audio sources are rendered with a reduction (R2>0) in the ratio of indirect audio to direct audio.

In some examples, when, during the audio intelligibility mode or audio accessibility mode, a priority speech audio source is rendered with a first reduction in the ratio of indirect audio to direct audio, then all other non-speech audio sources are rendered with a reduction in the ratio of indirect audio to direct audio.

In some examples, a non-speech audio object can be a priority audio object only when there is no priority speech object.

The priority of an audio source can be dependent on one or more various factors.

In some examples, the per audio source priority is dependent upon a listening position in a sound scene relative to the audio source. The listening position can be dependent upon a listening location and/or a listening environment and/or a listening orientation.

In some examples, the per audio source priority is dependent upon distance from the listening position to the audio source. In some examples, the per audio source priority is dependent upon a direct distance from the listening position to the audio source.

In some examples, the per audio source priority is dependent upon the path from the listening position to the audio source. For example, whether it is direct or whether it is indirect.

In some examples, the per audio source priority is dependent upon hearability of the audio source which is dependent upon at least a relative amplitude of the audio source. Hearability of the audio source can also be dependent upon a distance from the audio source to the listener. Hearability of the audio source can also be dependent upon relative amplitude of the audio source in specific frequency ranges and this may be calibrated for a user.

In some examples, the per audio source priority is dependent upon per audio object priority metadata in addition to that which indicates that the audio source is a speech audio object. In some examples, priority metadata is comprised in a scene description bitstream

In at least some examples, the listening position is controllable by a user of the apparatus 102. In at least some examples, the listening position is controlled to track at least a head orientation of the user. In at least some examples, the listening position is controlled to track a head orientation of the user of the apparatus 2 and a head location of the user. In some examples, the apparatus 102 is comprised in a head-mounted device.

In at least some examples, the audio sources are spatial audio sources. A spatial audio source is an audio source that has a controlled, variable, directionality (defined by metadata).

The accessibility mode can, for example, be a mode in which the user is consuming content (listening) and not speaking. The user is listening to speech (dialog) but is not actively participating in the dialog.

In at least some examples the accessibility mode is a Motion Picture Experts Group (MPEG) accessibility mode with a first reduction in the ratio of indirect audio to direct audio of the audio source, if it is a speech audio source, being controlled using reverbAttenuationDb and erAttenuationDb to lower the reverb and early-reflection levels in the renderer. This lowers the ratio of indirect audio to direct audio.

Reverb and/or early reflection levels are reduced so that they do not interfere with the direct path audio heard by the user, making the dialog easier to understand. The priority speech source (object) is rendered in a non-realistic dry manner suppressing audio effects such as reverb and early reflections.

A second reduction in the ratio of indirect audio to direct audio for the audio source, if it is not a speech audio source, is controlled using reverbAttenuationDb and erAttenuationDb to control the reverb and early-reflection levels in the renderer. This controls the ratio of indirect audio to direct audio.

FIG. 4A and 4B illustrate examples of metadata 112. In FIG. 4A, per source (object) metadata 142 is separate from the legacy metadata 140. In FIG. 4B, the per source (object) metadata 142 is part of the legacy metadata 140.

The metadata comprises legacy metadata that is currently defined by a standard e.g., MPEG-I. For example, the metadata 112 can define a scene description.

Per source (object) metadata 142 is added to the metadata 112 that indicates how the associated audio source (audio object) is to be rendered in the audio intelligibility mode or audio accessibility mode. In at least some examples, the per audio source metadata (per audio object metadata) indicates that the respective audio source (audio object) is a speech audio source (speech audio object). In at least some examples, the per source (object) metadata is content-creator-controlled, that is the content is controlled by a creator (author).

In FIG. 4A, the per source (object) metadata 142 that indicates how the associated audio source (audio object) is to be rendered in the audio intelligibility mode or audio accessibility mode, is separate from the legacy metadata 140.

In FIG. 4B, the per source (object) metadata 142 that indicates how the associated audio source (audio object) is to be rendered in the audio intelligibility mode or audio accessibility mode, is part of the legacy metadata 140.

FIG. 5 illustrates an example of a system comprising an encoder apparats 2 and a decoder apparatus 102. In these examples, but not necessarily all examples, the encoder apparatus 2 and the decoder apparatus 102 communicate via a server apparatus 120.

The encoder apparatus 2 comprises means for encoding an audio bitstream 122 including per audio object command information (metadata 112) to control a decoder 102 operation during an audio intelligibility or audio accessibility mode, wherein the per object command information 142 identifies an audio source (object) as a speech source (object) for differential rendering.

In at least some examples, the per object command information 142 is per source (object) metadata 142.

An encoder circuit 116 receives an imetadata 112 according to an encoder Input Format (EIF) specification, comprising an authoring parameter for defining the per object command information identifying the audio object as a speech object for differential rendering. An EIF-file for a scene contains the whole scene description, including the new authoring parameters. The encoder circuity 116 is configured to insert the authoring parameter into the bitstream similarly to the other authoring parameter flags.

The metadata 122 can, for example, comprise a flag indicating whether the audio source (object) contains speech for defining the per source (object) command information identifying the audio source (object) as a speech source (object) for differential rendering.

The per source (object) metadata 142 is configured to control a decoder operation during an audio intelligibility or audio accessibility mode to render a priority audio source (object) with a reduction in a ratio of indirect audio to direct audio compared to a another mode, if it is a speech source (object) and with a second reduction, or no reduction, in a ratio of indirect audio to direct audio compared to the another mode, if it is not a speech source (object), wherein the second reduction is less than the first reduction.

In some examples, the encoder circuitry 116 is configured to insert into the audio bitstream 122 per audio object prioritization information to control prioritization of the audio object. In some examples, the prioritization information defines a hearability threshold (for example a distance threshold) for the speech source (object).

The decoder apparatus 102 comprises means for:
providing an audio intelligibility mode or audio accessibility mode in which a ratio of indirect audio to direct audio for an audio source is reduced compared to another mode on a per audio source basis
wherein
a priority audio source is rendered:
with a first reduction in the ratio of indirect audio to direct audio, if it is a speech audio source; and
with a second reduction, or no reduction, in the ratio of indirect audio to direct audio, if it is not a speech audio source, wherein the second reduction is less than the first reduction.

The decoder apparatus 102 decodes the received audio bitstream 122 to obtain the audio data and at least the per source (object) metadata 142 which is used to control decoder operation during an audio intelligibility or audio accessibility mode. The per source (object) metadata 142 identified an audio source (object) as a speech source (object) for differential rendering. In some examples, the per source (object) metadata 142 identifies a prioritization condition to be used to determine whether or nor a speech audio object is a priority speech audio object.

In some examples, the decoder apparatus 102 is also a rendering apparatus.

In some examples, the decoder apparatus 102 is a headset. In some examples, the headset comprise means for tracking and orientation (and optionally a potion) of a user's head and for providing binaural audio output.

FIGS. 6, 7 and 8, illustrate examples where a user of the apparatus 102 perceives an audio scene 40 as if they where a listener 2, having a position in the audio scene 40.

The position (location and orientation) of the listener 2 tracks a position (location and orientation) of a user of an apparatus 102.

Direct speech audio sources 10_1, 10_2 provide direct audio a listener 2. Indirect speech audio sources 20_1, 20_2 provide indirect audio to a listener 2. They represent the reflections of the respective direct speech audio sources 10_1, 10_2 off walls. Direct music audio sources 12 provide direct audio to a listener 2. Indirect music audio sources 22 provide indirect audio to a listener 2. They represent the reflections of the respective direct music audio sources 12 off walls. The direct speech audio sources 10_1, 10_2 and their associated indirect speech audio sources 20_1, 20_2 are in a first room. The direct music audio sources 12 and their associated indirect music audio sources 22. are in a second room interconnected to the first room through an open door.

In FIG. 6, the accessibility mode is NOT operational. The listener 2 is proximal to the direct speech audio sources 10_1, 10_2 and distal from the direct music audio sources 12. The direct speech audio sources 10_1, 10_2 are closer to the listener 2 than a notional hearing threshold distance and would therefore be classified as priority audio sources. The direct music audio sources 12 are further from the listener 2 than a notional hearing threshold distance and would therefore be classified as non-priority audio sources.

However, because the accessibility mode is NOT operational, the apparatus 102 renders realistic audio effects using realistic (higher) values of the ratio of indirect audio to direct audio. The direct music audio sources 12 and all their associated indirect music audio sources 22 are rendered. The direct speech audio sources 10_1, 10_2 and all their associated indirect speech audio sources 20_1, 20_2 are rendered. FIG. 6 corresponds to block 204 in FIGS. 2 & 3.

In FIG. 7, the accessibility mode is operational. The listener 2 is proximal to the direct speech audio sources 10_1, 10_2 and distal from the direct music audio sources 12. The direct speech audio sources 10_1, 10_2 are closer to the listener 2 than a notional hearing threshold distance and are therefore classified as priority audio sources. The direct music audio sources 12 are further from the listener 2 than a notional hearing threshold distance and are therefore classified as non-priority audio sources.

As the accessibility mode is operational, and there is a priority speech audio source, the apparatus 102 does not render realistic audio effects using realistic values of the ratio of indirect audio to direct audio. The apparatus 102 renders audio effects for intelligibility/accessibility of speech. The audio sources are rendered with a first reduction in the ratio of indirect audio to direct audio compared to block 204.

The direct speech audio sources 10_1, 10_2 are rendered. A sub-set (or none) of the associated indirect speech audio sources 20_1, 20_2 are rendered with reduced intensity. Some (or all) indirect speech audio sources 20_1, 20_2 are absent 30_1, 30_2.

The direct music audio sources 12 are rendered. A sub-set (or none) of the associated indirect speech audio sources 22 are rendered with reduced intensity. Some (or all) indirect speech audio sources 22 are absent 32.

FIG. 7 corresponds to block 210 in FIGS. 2 & 3. The priority speech object is rendered in a non-realistic dry manner suppressing audio effects such as reverb and early reflections.

In FIG. 8, the accessibility mode is operational. The listener 2 is distal from the direct speech audio sources 10_1, 10_2 and proximal to the direct music audio sources 12. The direct speech audio sources 10_1, 10_2 are further from the listener 2 than a notional hearing threshold distance and are therefore classified as non-priority audio sources. The direct music audio sources 12 are closer to the listener 2 than a notional hearing threshold distance and are therefore classified as priority audio sources.

As the accessibility mode is operational, but there is a no priority speech audio source, the apparatus 102 does not render audio effects for intelligibility/accessibility of speech as in FIG. 7. The audio sources are not rendered with a first reduction in the ratio of indirect audio to direct audio compared to block 204. Instead, the audio sources are rendered with a second (smaller) reduction in the ratio of indirect audio to direct audio compared to FIG. 6 or with no reduction in the ratio of indirect audio to direct audio compared to FIG. 6.

A reduction in the ratio of indirect audio to direct audio can be controlled by controlling the number of indirect audio sources rendered and by controlling an intensity of the indirect audio sources rendered.

FIG. 8 corresponds to block 208 in FIGS. 2 & 3. The music is rendered in a realistic wet manner including audio effects such as reverb and early reflections In FIG. 8, the apparatus 102 renders audio effects that are not the same as those used for intelligibility/accessibility of speech in FIG. 7. The constraints applied in FIG. 7 for intelligibility/accessibility of speech are loosened so that the audio sources are rendered like or more like they are in FIG. 6 and less like they are in FIG. 7. That is more realistically, wetter. The audio source(s) is/are rendered with a second reduction, or no reduction, in the ratio of indirect audio to direct audio first compared to FIG. 6.

Thus, during the audio intelligibility mode (or audio accessibility mode) a priority speech audio source is rendered (FIG. 7) with a first reduction in the ratio of indirect audio to direct audio compared to another mode (FIG. 6) if it is a priority speech object and otherwise is rendered with a second reduction, or no reduction, in the ratio of indirect audio to direct audio (FIG. 8).

In the example of FIG. 6, a user (listener 2) is experiencing a VR scene with two rooms. In one room there is some dialog happening between two characters. The dialog is rendered via two audio sources 10_1, 10_2 at the position of the characters. The dialog is rendered in a realistic manner including audio effects such as reverb and early reflections 20_1, 20_2. In the other room there are audio source 12 related to a band playing some music. The music reverberates 22 in the other room.

Referring to FIG. 7, in highly reverberated environments, the user selects ‘audio accessibility’ to increase speech accessibility by decreasing the overall reverb level (decreasing the level of indirect audio). In the current version of the MPEG-I audio standard, an accessibility API may be used to instruct the audio renderer to lower reverb or early reflection levels (reduce the ratio of indirect audio to direct audio). This can be achieved by removing indirect audio sources or by lowering the intensity of indirect audio sources.

If the user has lowered the reverb levels via the accessibility API, on entering the other ‘music’ room his experience would be sub-optimal. The lower ratio of indirect audio to direct audio would lower the experience when it comes to the music and there is no gains in speech intelligibility as the listener 2 is too far away from the dialog of audio sources 10_1, 10-2 to hear to hear it even with the lowered reverb. This suboptimal user experience is addressed and improved in FIG. 8.

Referring to FIG. 8, the user (listener 2) is in the other ‘music’ room. Music being played via the audio sources 12. Room parameters have been tuned to create a nice sounding reverb so that the overall experience for the user is good/optimal (note that audio sources 22A, missing in FIG. 7 are present in FIG. 8 and the intensity of the audio sources (indicated by their size in the FIG) are increased relative to FIG. 7). If the user has lowered the reverb levels via the accessibility API, on entering the music room, reverb levels are not lowered (or not lowered as much) as the user stands to gain nothing from doing so.

In this example a content creator has indicated, via metadata, that the audio sources 10_1, 10_2 are “dialog” objects (and the audio sources 12 are not).

The reverb levels are lowered (FIG. 7) only if the user is close enough to the dialog objects 10_1, 10_2 that he can actually hear them. This way, the user's experience is kept at a high level when there is no dialog to be heard (FIG. 8) and speech is intelligible when he is able to hear it (FIG. 7).

FIGS. 9A, 9B, 9C extend the example of FIGS. 7 and 8.

FIG. 9A corresponds to FIG. 7, where the listener is proximal to the speech and distal from the music. FIG. 9C corresponds to FIG. 8., where the listener is proximal to the music and distal from the speech. In FIG. 9B, the listener is at a position intermediate that in FIG. 9A and 9B.

These FIGs illustrate that the priority of a speech audio source audio source 10_1, 10_2 can be based on the distance of the listener 2 from the audio sources.

In FIGS. 9A, 9B the distance of the listener 2 from the audio sources 10-1, 10_2 is less than a threshold distance. The speech audio sources 10-1, 10_2 are classified as priority audio sources and because the accessibility mode is active, the indirect audio to direct audio ratio is reduced to a low level.

In FIG. 9C the distance of the listener 2 from the audio sources 10_1, 10_2 has increased beyond the threshold distance. The speech audio sources 10_1, 10_2 are classified as non-priority audio sources and because the accessibility mode is active, the indirect audio to direct audio ratio is not reduced or reduced less. In comparison to FIGS. 9A, 9B, in FIG. 9C, the indirect audio to direct audio ratio is increased because there is no longer a priority speech audio source.

The threshold distance can be adjusted based on hearability. This can, for example, be specific to a user if they have hearing loss. The threshold distance may be different for different frequencies.

Instead of using a threshold distance to classify a priority of a speech audio source, the room location of the listener 2 could be used. Thus if the listener 2 is in the same room as a speech audio source it is classified as a priority speech audio source and the ratio of indirect audio to direct audio is reduced significantly. If the listener 2 is not in the same room as the speech audio sources, they are classified as a non-priority speech audio source and the ratio of indirect audio to direct audio is not-reduced or not reduced significantly.

In FIG. 9A, the listener 2 can hear the speech audio sources 10_1, 10_2 and they are prioritized. The ratio of indirect audio to direct audio is lowered for all audio sources (speech and music) 10, 20; 12, 22.

In FIG. 9B, the listener 2 can hear the speech audio sources 10_1, 10_2 and they are prioritized over music. The ratio of indirect audio to direct audio is lowered for all audio sources (speech and music) 10, 20; 12, 22.

In FIG. 9C, the listener 2 cannot hear the speech audio sources 10_1, 10_2 and they are not prioritized. The ratio of indirect audio to direct audio is increased compared to FIGS. 9A & 9B for all audio sources (speech and music) 10, 20; 12, 22.

The above described methods enable content creator controlled accessibility rendering modifications for rendering of 6DoF audio scenes. In some examples, there is an indication, in the scene description (bitstream), of audio object types so that they may be rendered in a proper manner when accessibility features are used.

For an example, in FIG. 9C, the user has lowered reverb levels via an accessibility API. The content creator has indicated that the audio sources 10_1, 10 (2 are “dialog” objects. The audio sources 12 associated with the music have not been indicated to be “dialog” objects. In this case, the reverb level is not decreased. The reverb levels are lowered only if the user is close enough to the dialog objects that he can actually hear them (FIG. 9A, 9B). This way, the user's experience is kept at a high level when there is no dialog to be heard and speech is intelligible when he is able to hear it.

FIG. 5 shows an example system. The figure shows a (simplified) block diagram of the system in MPEG-I audio context. To implement the invention, changes are required in the Encoder Input Format (EIF) specification, encoder, and the decoder/renderer.

The following changes can be made to Encoder Input Format:

<ObjectSource>
Declares an ObjectSource which emits sound into the virtual scene. The ObjectSource has a
position/orientation in space. The radiation pattern can be controlled by a directivity. If no
directivity attribute is present, the source radiates omnidirectional. Optionally it can have a spatial
extent, which is specified through a geometric object. If no extent is specified, the source is a
point source. The signal component of the ObjectSource must contain at least one waveform.
When the signal has multiple waveforms, the spatial layout of these waveforms must be specified
in an <InputLayout> subnode

| Child node | Count | Description | | |
|---|---|---|---|---|
| <InputLayout> | 0 . . . 1 | Signal positioning (required when signal has multiple | | |
| | | waveforms) | | |
| Attribute | Type | Flags | Default | Description |
| id | ID | R | | Identifier |
| position | Position | R, M | | Position |
| orientation | Rotation | O, M | (0° 0° 0°) | Orientation |
| cspace | Coordinate | O | relative | Spatial frame of reference |
| | space | | | |
| active | Boolean | O, M | true | If true, then render this source |
| gainDb | Gain | O, M | 0 | Gain (dB) |
| refDistance | Float > 0 | O | 1 | Reference distance (m) (see comment |
| | | | | below) |
| signal | AudioStream ID | R, M | | Audio stream |
| extent | Geometry ID | O, M | none | Spatial extent |
| directivity | Directivity ID | O, M | none | Sound radiation pattern |
| directiveness | Value | O, M | 1 | Directiveness (see 3.4.1) |
| aparams | Authoring | O | none | Authoring parameters (see 4.13) |
| | parameters | | | |
| mode | Playback mode | O | continuous | Playback mode {“continuous”, “event”} |
| play | Boolean | O, M | False | Playback enabled? |

Where a params is

| Value | Description |
|---|---|
| noReverb | Omits reverb simulation (e.g. when source |
| | signal is reverberant) |
| noDoppler | Omit the simulation of Doppler shifts (e.g. |
| | when these are already contained in the |
| | signal) |
| noDistance | Omit distance attenuation (e.g. when it is |
| | already contained in the signal) |
| noRescale | Omit audio source rescaling (e.q. when the |
| | element's position should not change w.r.t. an |
| | anchor object) |
| dialog | This element is a dialog element. (affects how |
| | accessibility settings affect the rendering of |
| | this element |

There is a new parameter, “dialog”, for the authoring parameters (aparams) that are associated with audio elements such as audio objects.

The content creator may use the dialog flag to indicate whether the audio object contains dialog. This will then instruct the renderer to handle the rendering of this audio object differently to non-dialog audio objects when the accessibility API is used.

The dialog flag is inserted into the bitstream by the encoder based on its setting in the scene EIF similarly to the other authoring parameter flags. Below, is the updated bitstream syntax for an audio object source (changes on top of the current MPEG-I Audio working draft are highlighted in yellow):

| Syntax | No. of bits | Mnemonic |
|---|---|---|
| objectSources( ) | | |
| { | | |
| objectSourcesCount = GetCountOrIndex( ); | | |
| for (int i = 0; i < objectSourcesCount; i++) { | | |
| hasInputLayout; | 1 | bslbf |
| if (hasInputLayout) { | | |
| inputLayoutAlignment; | 1 | bslbf |
| inputLayoutTL; | 1 | bslbf |
| inputLayoutT; | 1 | bslbf |
| inputLayoutTR; | 1 | bslbf |
| inputLayoutL; | 1 | bslbf |
| inputLayoutC; | 1 | bslbf |
| inputLayoutR; | 1 | bslbf |
| inputLayoutBL; | 1 | bslbf |
| inputLayoutB; | 1 | bslbf |
| inputLayoutBR; | 1 | bslbf |
| } | | |
| objectSourceId = GetID( ); | | |
| [objectSourcePositionX; | | |
| objectSourcePositionY; | | |
| objectSourcePositionZ;] = | | |
| GetPosition(isSmallScene) | | |
| [objectSourceOrientationYaw; | | |
| objectSourceOrientationPitch; | | |
| objectSourceOrientationRoll] = | | |
| GetOrientation( ); | | |
| objectSourceCoordSpace; | 1 | bslbf |
| objectSourceActive; | 1 | bslbf |
| objectSourceGainDb = | | |
| GetGain(isHiPrecGain=True); | | |
| objectSourceRefDistance = | | |
| GetDistance(isSmallScene); | | |
| objectSourceSignalId = GetID( ); | | |
| objectSourceHasExtent; | 1 | bslbf |
| if (objectSourceHasExtent) { | | |
| objectSourceExtentId = GetID( ); | | |
| } | | |
| objectSourceHasDirectivity; | 1 | bslbf |
| if (objectSourceHasDirectivity) { | | |
| objectSourceDirectivityId = GetID( ); | | |
| } | | |
| objectSourceDirectiveness; | 8 | uimsbf |
| objectSourceNoReverb; | 1 | bslbf |
| objectSourceNoDoppler; | 1 | bslbf |
| objectSourceNoDistance; | 1 | bslbf |
| objectSourceDialog; | 1 | bslbf |
| objectSourceMode; | 1 | bslbf |
| objectSourcePlay; | 1 | Bslbf |
| objectSourceVDLMethod; | 3 | uimsbf |
| objectSourceHasSpatialTransform; | 1 | bslbf |
| if (objectSourcehasSpatialTransform){ | | |
| objectSourceHasAnchor; | 1 | bslbf |
| if (objectSourceHasAnchor){ | | |
| objectSourceParenAchorId | | |
| = GetID( ); | | |
| } | | |
| else { | | |
| objectSourceParentTransformId = GetID( ); | | |
| } | | |
| } | | |
| objectSourceIsStatic; | 1 | bslbf |
| } | | |
| } | | |

Note that the new ObjectSourcedialog is included.

The decoder reads the bitstream and assigns audio objects to be “dialog” objects based on the objectSourceDialog bit. In some examples, during rendering, if the accessibility API is used to lower reverb levels by providing the reverbAttenuationDb or erAttenuationDb parameters, the renderer checks if the listener is further than a set threshold distance from all “dialog” audio objects. If this is the case, then the provided parameters do not have an effect. If the settings are kept “on” and the user moves closer to a “dialog” object, the reverb levels are lowered normally.

In some examples, the threshold distance (Threshold distance for disabling reverb level adjustment) is be added to the bitstream by the encoder according to content creator wishes. The threshold distance value is read by the decoder and user in rendering.

In some examples, a dynamic threshold (Threshold distance for disabling reverb level adjustment) is used that is based on the level of the “dialog” audio objects at listener position. The renderer determines the level of the “dialog” objects heard at the listener position and if the level is too low, the reverb levels are not lowered when instructed to do so by the accessibility API.

FIG. 10 illustrates a method 500 for providing an audio intelligibility mode or audio accessibility mode in which a ratio of indirect audio to direct audio for an audio source is controlled.

At block 502, it is determined if an audio source is a priority speech audio source.

At block 504, if it has been determined that the audio source is a priority speech audio source, the method 500 causes rendering of the audio source with a first ratio of indirect audio to direct audio.

At block 506, if it has been determined that the audio source is not a priority speech audio source, the method 500 causes rendering of the audio source with a second ratio of indirect audio to direct audio.

The first ratio of indirect audio to direct audio is lower than the second ratio of indirect audio to direct audio.

FIG. 11 illustrates an example of a controller 400 suitable for use in an apparatus 2, 102. Implementation of a controller 400 may be as controller circuitry. The controller 400 may be implemented in hardware alone, have certain aspects in software including firmware alone or can be a combination of hardware and software (including firmware).

As illustrated in FIG. 11 the controller 400 may be implemented using instructions that enable hardware functionality, for example, by using executable instructions 406 in a general-purpose or special-purpose processor 402 that may be stored on a machine readable storage medium (disk, memory etc.) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores instructions, program, or code 406 that controls the operation of the apparatus 102 when loaded into the processor 402. The computer program instructions, program or code am 406, provide the logic and routines that enables the apparatus 102 to perform the methods illustrated in the accompanying FIGs. The processor 402 by reading the memory 404 is configured to load and execute the instructions, program, or code 406.

The apparatus 102 comprises:
at least one processor 402; and
at least one memory 404 storing instructions that, when executed by the at least one processor 402, cause the apparatus at least to:
determine if an audio source is a priority speech audio source;
if an audio source is a priority speech audio source, cause rendering of the audio source with a first ratio of indirect audio to direct audio,
and
if the audio source is not a priority speech audio source, cause rendering of the audio source with a second ratio of indirect audio to direct audio, wherein the first ratio of indirect audio to direct audio is lower than the second ratio of indirect audio to direct audio.

As illustrated in FIG. 12, the instructions, program, or code 406 may arrive at the apparatus 102 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 102 may propagate or transmit the computer program 406 as a computer data signal.

The term “non-transitory” as used herein, is a limitation of the medium itself (i.e., tangible, not a signal) as opposed to a limitation on data storage persistency (e.g., RAM vs. ROM).

Computer program instructions for causing an apparatus to perform at least the following or for performing at least the following:
determine if an audio source is a priority speech audio source;
if an audio source is a priority speech audio source, cause rendering of the audio source with a first ratio of indirect audio to direct audio,
and
if the audio source is not a priority speech audio source, cause rendering of the audio source with a second ratio of indirect audio to direct audio, wherein the first ratio of indirect audio to direct audio is lower than the second ratio of indirect audio to direct audio.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all the following:
(a) hardware-only circuitry implementations (such as implementations in only analog and/or digital circuitry) and
(b) combinations of hardware circuits and software, such as (as applicable):
i. a combination of analog and/or digital hardware circuit(s) with software/firmware and
ii. any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the claim element, a baseband integrated circuit for a mobile device or a similar integrated circuit in a server, a cellular network device, or other computing or network device.

The blocks illustrated in the accompanying Figs may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

As used here ‘module’ refers to a unit or apparatus that excludes certain parts/components that would be added by an end manufacturer or a user. The apparatus 2, 102 can, for example be a module. A controller 400 of the apparatus 2, 102 can, for example be a module.

Where a structural feature has been described, it may be replaced by means for performing one or more of the functions of the structural feature whether that function or those functions are explicitly or implicitly described.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure.

Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to ‘comprising only one . . . ’ or by using ‘consisting.’

In this description, the wording ‘connect’, ‘couple’ and ‘communication’ and their derivatives mean operationally connected/coupled/in communication. It should be appreciated that any number or combination of intervening components can exist (including no intervening components), i.e., to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database, or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’, or ‘may’ refers to a particular instance in a class of examples. A property of the instance can be a property of only that instance or a property of the class or a property of a sub-class of the class that includes some but not all the instances in the class. It is therefore implicitly disclosed that a feature described with reference to one example but not with reference to another example, can where possible be used in that other example as part of a working combination but does not necessarily have to be used in that other example.

As used herein, “at least one of the following: ” and “at least one of” and similar wording, where the list of two or more elements are joined by “and” or “or” mean at least any one of the elements, or at least any two or more of the elements, or at least all the elements.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

The description of a feature, such as an apparatus or a component of an apparatus, configured to perform a function, or for performing a function, should additionally be considered to also disclose a method of performing that function. For example, description of an apparatus configured to perform one or more actions, or for performing one or more actions, should additionally be considered to disclose a method of performing those one or more actions with or without the apparatus.

Although features have been described with reference to certain examples, those features may also be present in other examples whether described or not. The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance the Applicant may seek protection via the claims in respect of any patentable feature or combination of features hereinbefore referred to and/or shown in the drawings whether or not emphasis has been placed thereon.

1-25. (canceled)

26. An apparatus comprising:
at least one processor; and
at least one memory storing instructions that, when executed by the at least one processor, cause the apparatus at least to:
provide an audio intelligibility mode or audio accessibility mode in which a ratio of indirect audio to direct audio for an audio source is reduced compared to another mode on a per audio source basis,
wherein
a priority audio source is rendered:
with a first reduction in the ratio of indirect audio to direct audio, when the audio source is a speech audio source; and
with a second reduction, or no reduction, in the ratio of indirect audio to direct audio, when the audio source is not the speech audio source, wherein the second reduction is less than the first reduction.

27. An apparatus as claimed in claim 26, wherein the apparatus is further caused to identify an audio source as the speech audio source based on per audio source metadata that indicates how the audio source is to be rendered in the audio intelligibility mode or audio accessibility mode.

28. An apparatus as claimed in claim 27, wherein the per audio source metadata indicates that the audio source is a speech audio source.

29. An apparatus as claimed in claim 27, wherein the per audio source metadata is content-creator-controlled.

30. An apparatus as claimed in claim 26, wherein, when, during the audio intelligibility mode or audio accessibility mode, a priority speech audio source is rendered with a first reduction in the ratio of indirect audio to direct audio, non-priority audio sources are rendered with a reduction in the ratio of indirect audio to direct audio.

31. An apparatus as claimed in claim 26, wherein, when, during the audio intelligibility mode or audio accessibility mode, a priority speech audio source is rendered with a first reduction in the ratio of indirect audio to direct audio, then all other non-speech sources are rendered with a reduction in the ratio of indirect audio to direct audio.

32. An apparatus as claimed in claim 26, wherein the another mode is a mode operational when the audio intelligibility mode or audio accessibility mode has not been user activated.

33. An apparatus as claimed in claim 26, wherein a per audio source priority is dependent upon a listening position in a sound scene relative to the audio source.

34. An apparatus as claimed in claim 33, wherein the listening position is dependent upon at least one of a listening location, a listening environment or a listening orientation.

35. An apparatus as claimed in claim 33, wherein the per audio source priority is dependent upon a distance from the listening position to the audio source.

36. An apparatus as claimed in claim 33, wherein the per audio source priority is dependent upon a direct distance from the listening position to the audio source.

37. An apparatus as claimed in claim 33, wherein the listening position is controlled to track a head position of a user of the apparatus, location of the user of the apparatus, and orientation of the user of the apparatus.

38. An apparatus as claimed in claim 26, wherein a per audio source priority is dependent upon hearability of the audio source, which is dependent upon at least relative amplitude of the audio source.

39. An apparatus as claimed in claim 26, wherein a per audio source priority is dependent upon per audio source metadata.

40. An apparatus as claimed claim 26, wherein the accessibility mode is an Moving Picture Experts Group accessibility mode with the first reduction in the ratio of indirect audio to direct audio of the audio source, when the audio source is a priority speech audio source, being controlled using reverbAttenuationDb and erAttenuationDb and/or wherein the second reduction in the ratio of indirect audio to direct audio for the audio source, when the audio source is not the priority speech audio source, being controlled using the reverbAttenuationDb and the erAttenuationDb.

41. A method, comprising:
providing an audio intelligibility mode or audio accessibility mode in which a ratio of indirect audio to direct audio for an audio source is controlled, wherein when an audio source is a priority speech audio source;
rendering of the audio source with a first ratio of indirect audio to direct audio;
and
when the audio source is not the priority speech audio source,
rendering the audio source with a second ratio of indirect audio to direct audio, wherein the first ratio of indirect audio to direct audio is lower than the second ratio of indirect audio to direct audio.

42. A method as claimed in claim 41, further comprising identifying an audio source as a speech audio source based on per audio source metadata that indicates how the audio source is to be rendered in the audio intelligibility mode or audio accessibility mode.

43. A method as claimed in claim 42, wherein the per audio source metadata indicates that the audio object is a speech audio object.

44. A method as claimed in claim 41, wherein a per audio source priority is dependent upon a listening position in a sound scene relative to the audio source.

45. A non-transitory computer readable medium comprising program instructions stored thereon for performing at least the following:
providing an audio intelligibility mode or audio accessibility mode in which a ratio of indirect audio to direct audio for an audio source is controlled,
determining whether an audio source is a priority speech audio source;
when an audio source is the priority speech audio source, cause rendering of the audio source with a first ratio of indirect audio to direct audio;
and
when the audio source is not the priority speech audio source, cause rendering of the audio source with a second ratio of indirect audio to direct audio, wherein the first ratio of indirect audio to direct audio is lower than the second ratio of indirect audio to direct audio.
